(19) United States
(12) Patent Application Publication
(10) Pub. No.: US 2022/0213715 A1
(43) Pub. Date: Jul. 7, 2022

(54) Cylinder Lock With Improved Strength

(71) Applicant: SPARK TECHNOLOGY ENGINEERING LTD, Hayes (GB)

(72) Inventor: Hinesh Patel, Hounslow (GB)

(21) Appl. No.: 17/603,629

(22) PCT Filed: Apr. 6, 2020
(86) PCT No.: PCT/GB2020/000038

§ 371 Date: Oct. 14, 2021

(30) Foreign Application Priority Data
Apr. 24, 2019 (GB) 1905764.5

(51) Int. Cl. E05B 9/04; E05B 9/10; E05B 17/04

(52) U.S. Cl. CPC E05B 9/048; E05B 9/042; E05B 47/0038; E05B 17/042; E05B 17/045; E05B 9/10

(57) ABSTRACT

A cylinder lock (100) comprising first and second housing sides (104, 106), an actuator (120) which is positioned in a space (116) between the first and second housing sides (104, 106), and a connecting portion (200) which extends completely across the space (116) and connects the first and second housing sides (104, 106), and wherein the actuator (120) is rotatable about the connecting portion (200) in order to cause operation of locking means. The connecting portion (200) gives the cylinder lock (100) increased strength.

This invention relates to a cylinder lock and, more especially, this invention relates to a cylinder lock with improved strength.

Cylinders locks are known and widely used. They are often used, for example, in doors, shutters, windows, safes, lockers, padlocks, cases, boxes, drawers, and switches. The cylinder locks have the benefit that they can easily be installed and removed.

Known profile cylinder locks include those known as Euro cylinder, oval cylinder, and Swiss round cylinder. Such known cylinder locks usually comprise a housing with a cylindrical hole which houses a rotatable plug having a keyway and a number of pin, wafer, tumbler, disc, bar, ball, or other components which lock the plug to the housing. Insertion of a correct key into the keyway unlocks the plug, allowing it to be turned by an operator.

A cylinder lock may also be operated by a turnable control device such as a thumb turn, knob or handle. Alternatively, a cylinder lock may comprise a turnable control device to be operated with a tool, including a hex socket to be operated with a hex key, or a slot to be operated with a flat object, or a square head to be operated by a square socket.

A mechatronic cylinder lock may electronically authenticate a key, fob, remote, card, code entered by keypad, biometrics or other means. After authentication, there usually follows movement of a locking component that locks the plug or a turnable control device to a housing. A rotatable actuator is usually rotationally coupled to the plug or turnable control device, and a clutch may be used to provide a coupling that can be engaged or disengaged. In a mechatronic lock, a motor may be coupled to the actuator to rotate it. The actuator usually operates locking means such as a lock bolt, lock bar, latch, hook, pawl, cam or lock case, or locks/unlocks a device, or activates a switch.

The known cylinder locks have a weak joining portion, which causes the cylinder locks to break when subjected to loads applied by intruders. Various solutions have been provided to prevent breaking of the weak joining portion in the cylinder locks.

One proposed solution disclosed in WO 2007/099523 provides a thrower which axially connects first and second cylinder housings together so as to transfer axial pulling force applied to one of the cylinder housings to the other cylinder housing. Such a design may provide additional strength, however it may not be sufficient to prevent snapping during a typical attack.

The proposed solution in WO 2007/099523 has the disadvantage that when the lock is attacked, the thrower bears loads applied to the housing which may cause it to bind to the housing. This may hinder the thrower from being turned and render the lock inoperable. It may prevent an authorised operator from entering or exiting a building.

GB2372535 discloses a cylinder lock with a ductile joining element which connects two cylinder lock housing sections. The joining element is designed to deform by bending under load but not to break or fracture, thereby retaining the connection together of the housing parts.

Another proposed solution disclosed in EP2894279 provides a U-shaped security element fitted in a recess of the cylinder lock body to reinforce the joining portion. Other solutions have proposed using reinforcing elements.

GB2372535 and EP2894279 may provide some improvement to the problem of snapping during a typical attack. However, due to the limited amount of material in the joining portion, the effectiveness of the respective solutions is hindered.

GB2516323 discloses a cylinder lock with a novel profile shape that provides an increased area of material in the joining portion. Such a design may be effective. However the use of this profile shape is not well established, and it is not compatible with old door hardware. Consequently this cylinder lock has barriers to adoption in the lock industry.

GB2545389 discloses a cylinder lock with a body that comprises a remainder part, and a sacrificial part that breaks from the remainder part during a lock snapping attack. A security device is located in the remainder part. The security device comprises an immobiliser which actuates upon breaking of the sacrificial part, hindering movement of a plug relative to the remainder part. This proposed solution is unsatisfactory in that it deliberately weakens the lock rather than strengthening it, and once the immobiliser is actuated, it prevents an authorized operator from entering with a correct key. The lock will then usually need to be drilled to gain access and must be replaced.

It is an aim of the present invention to avoid or reduce the above mentioned problems, and to provide an improved strength cylinder lock.

Accordingly, in one non-limiting embodiment of the present invention there is provided a cylinder lock comprising first and second housing sides, an actuator which is positioned in a space between the first and second housing sides, and a connecting portion which extends completely across the space and connects the first and second housing sides, and wherein the actuator is rotatable about the connecting portion in order to cause operation of locking means.

The cylinder lock of the present invention advantageously has improved strength compared with known comparable cylinder locks.

The cylinder lock may be one in which the connecting portion is fixed with respect to the first and second housing sides.

The cylinder lock may include rotating means for rotating the actuator about the connecting portion. The rotating means may comprise a magnet. Alternatively, the rotating means may comprise two or more gears. Alternatively, the rotating means may comprise at least two sprockets, at least two pulleys, or at least one sprocket and one pulley. This rotating means may be coupled by appropriate coupling means such for example as a belt, a chain, a wire, a cable, a rope or a band. Alternatively, the rotating means may comprise two or more wheels which transmit rotation by friction.

The cylinder lock may be one which includes a plug or a turnable control device, and in which the plug or the turnable control device is rotatable in the connecting portion. The turnable control device may be, for example, a thumb turn, a knob, or a handle.

The cylinder lock may be one in which the connecting portion comprises at least one receiving portion, and in which the receiving portion is for receiving at least one locking component, or is for enabling at least one plug or at least one turnable control device to lock relative to the connecting portion. The receiving portion may be a hole, a slot, a groove, a notch or a depression.

The cylinder lock may be one in which the actuator is a cam, a cog wheel or a worm. Other types of actuator may be employed.

The cylinder lock may include a housing. The connecting portion may be integrally formed with housing components. Alternatively, the cylinder lock may be one in which the connecting portion has first and second sides, and in which one or both of the sides is connected to housing components by joining means. The joining means may be, for example, an interference fit, a pin, a screw, a clip, welding, brazing, soldering or an adhesive. Alternatively, the cylinder lock may be one in which the connecting portion includes an extending portion, and in which the extending portion extends into housing components for facilitating attachment of the extending portion to the housing components.

The cylinder lock may be one in which the rotating means is configured so that rotation of a plug or turnable control device provides equal rotation of the actuator. Alternatively, the rotating means may be configured so that one revolution of a plug or turnable control device provides one revolution of the actuator.

The cylinder lock may be one in which the rotating means is configured so that rotation of a plug or turnable control device rotates the actuator in the same direction. The direction may be clockwise or anticlockwise.

The cylinder lock may be one which requires power for operation, and in which the power is provided by an operator of the cylinder lock or by a motor. Thus, for example, the required power may be provided by an operator when turning a key or turning a turnable control device.

The cylinder lock may be one which includes a plug or a turnable control device, and in which the axis of the plug or the turnable control device and the axis of the actuator are offset.

The cylinder lock may be one which includes clutch means, and in which at least one component of the clutch means is at least partially housed within at least one component of the rotating means.

The cylinder lock may be one which includes clutch means and clutch transfer means, and in which at least one component of the clutch transfer means is at least partially housed within at least one component of the rotating means.

The cylinder lock of the present invention may be a Euro cylinder, an oval cylinder, or a Swiss round cylinder.

The present invention also provides a combination of a cylinder lock of the invention and the locking means.

The combination may be one in which the locking means is a mechanical locking means, or an electrical locking means. The mechanical locking means may be a lock bolt, lock bar, latch, hook, pawl, cam or lock case. The lock case may alternatively be known as a gear box. Other mechanical locking means may be employed. Any suitable electrical locking means may be employed, for example an electromagnetic device.

Embodiments of the invention will now be described solely by way of example and with reference to the accompanying drawings in which:

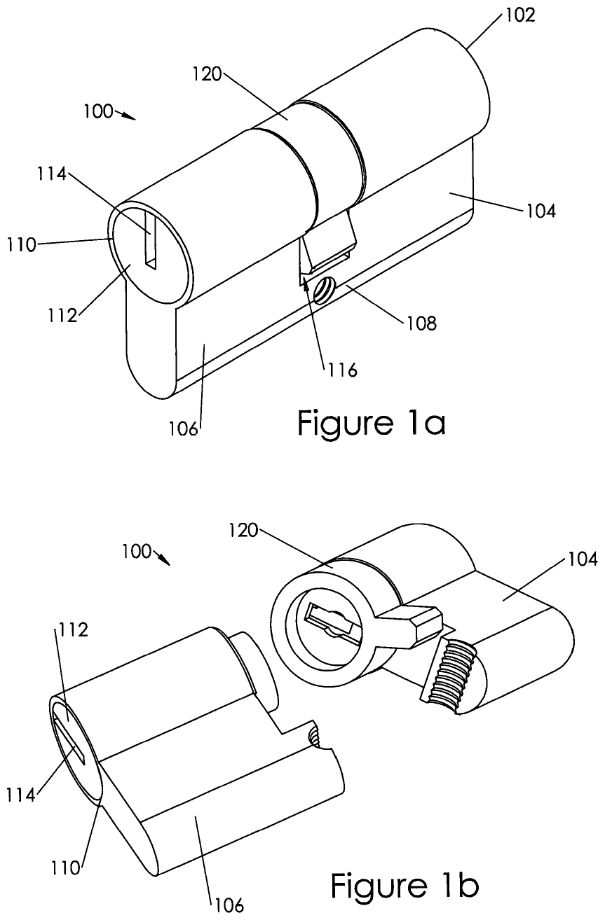

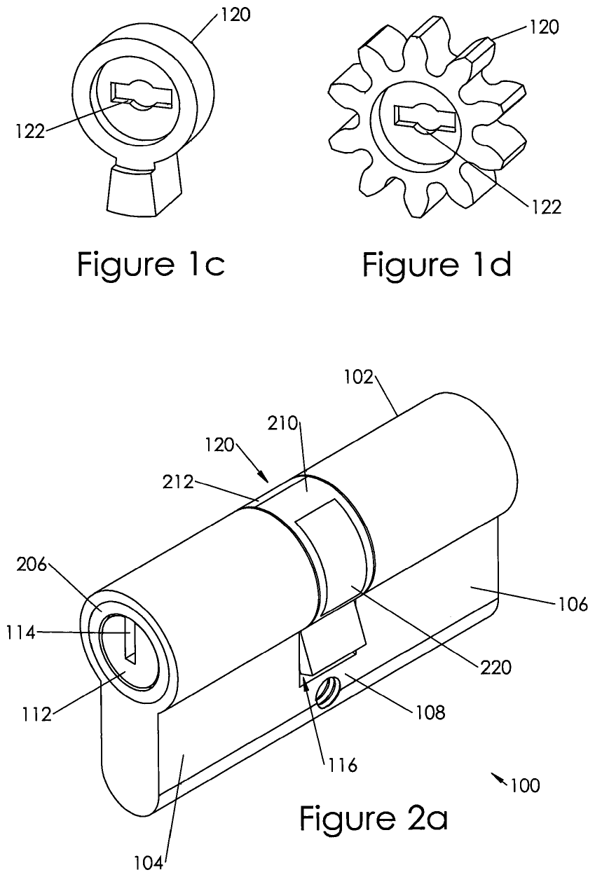

FIGS. 1a-b show various views of a known cylinder lock;

FIG. 1c shows a cam actuator for a known cylinder lock;

FIG. 1d shows a cog wheel actuator for a known cylinder lock;

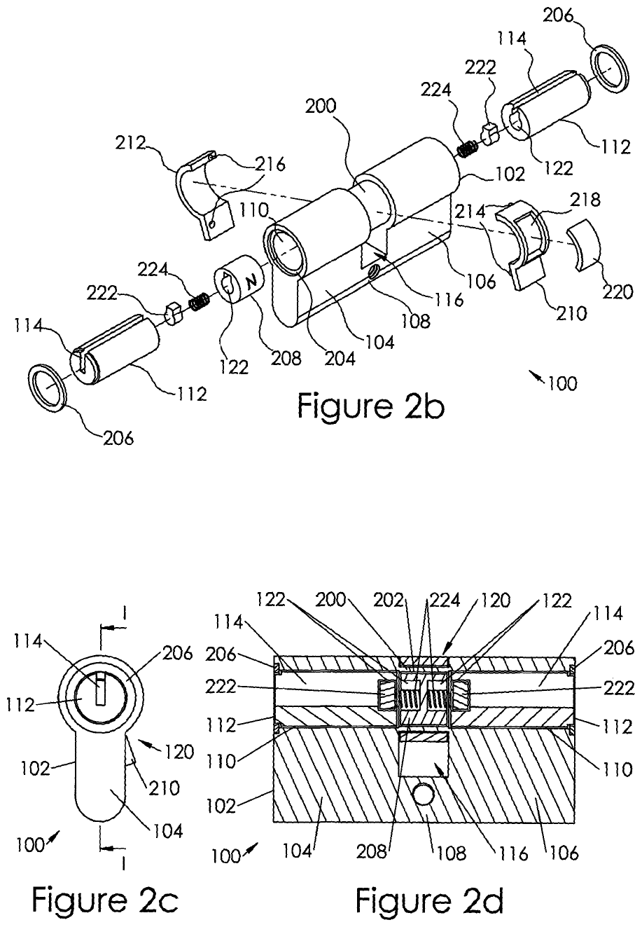

FIGS. 2a-d show various view of a first cylinder lock of the present invention;

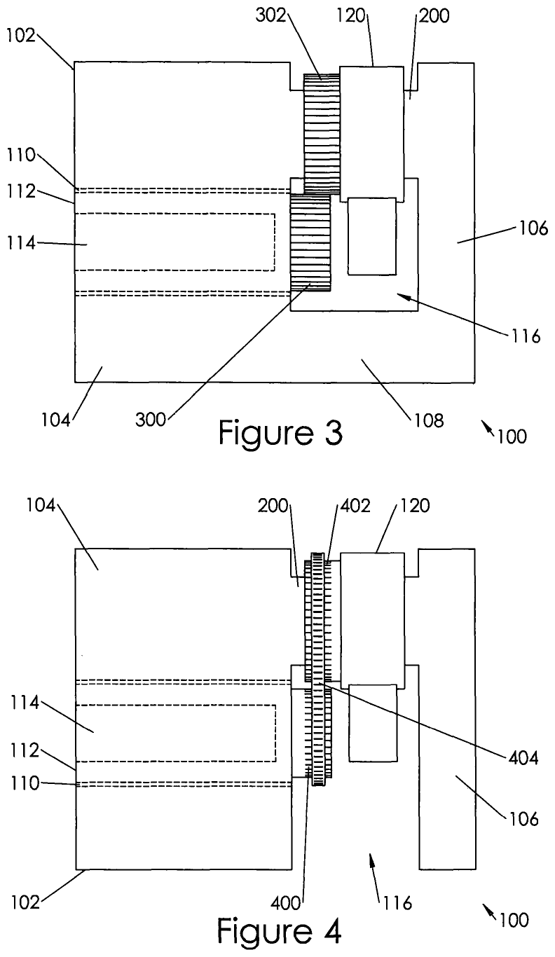

FIG. 3 shows a second cylinder lock of the present invention;

FIG. 4 shows a third cylinder lock of the present invention;

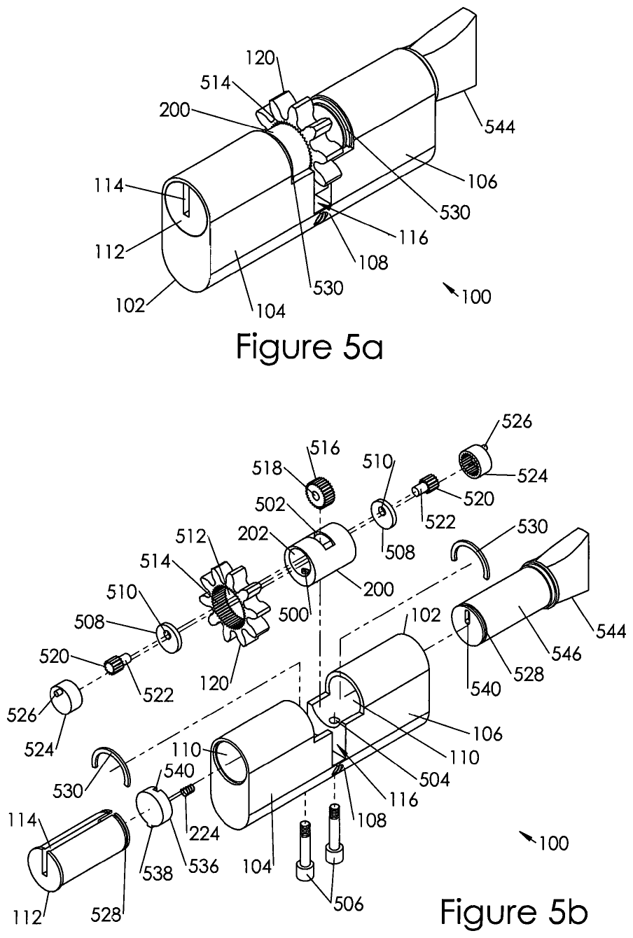

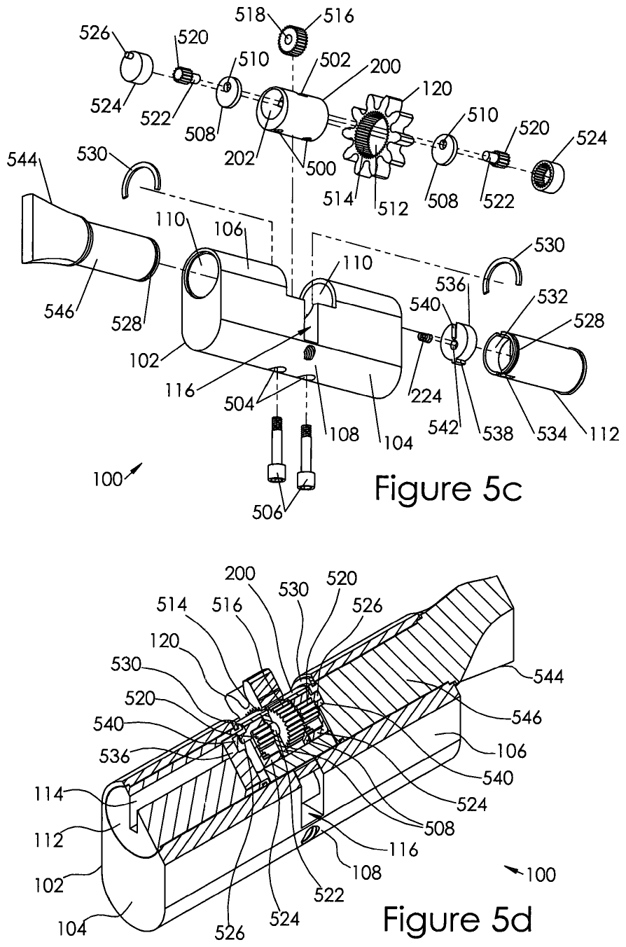

FIGS. 5a-d show a fourth cylinder lock of the present invention;

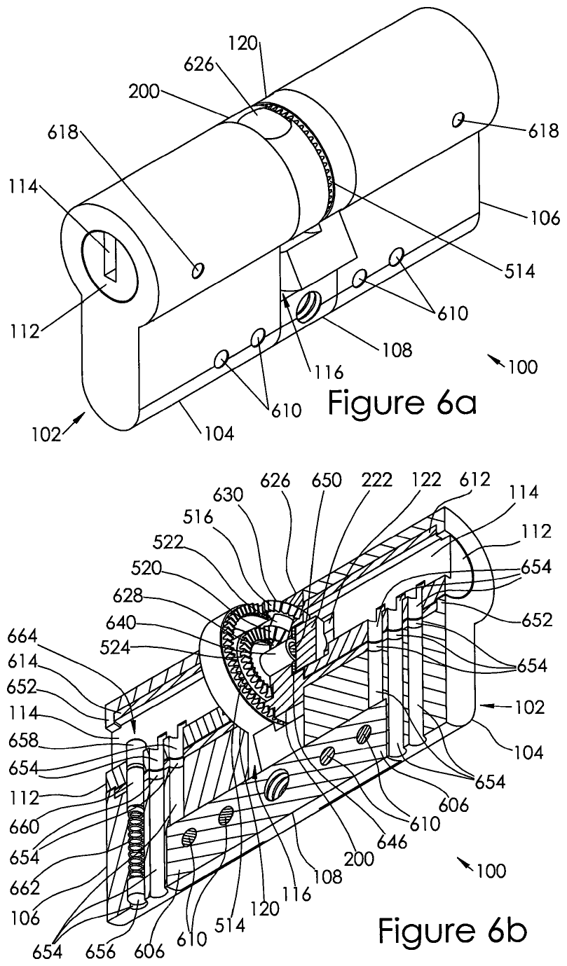

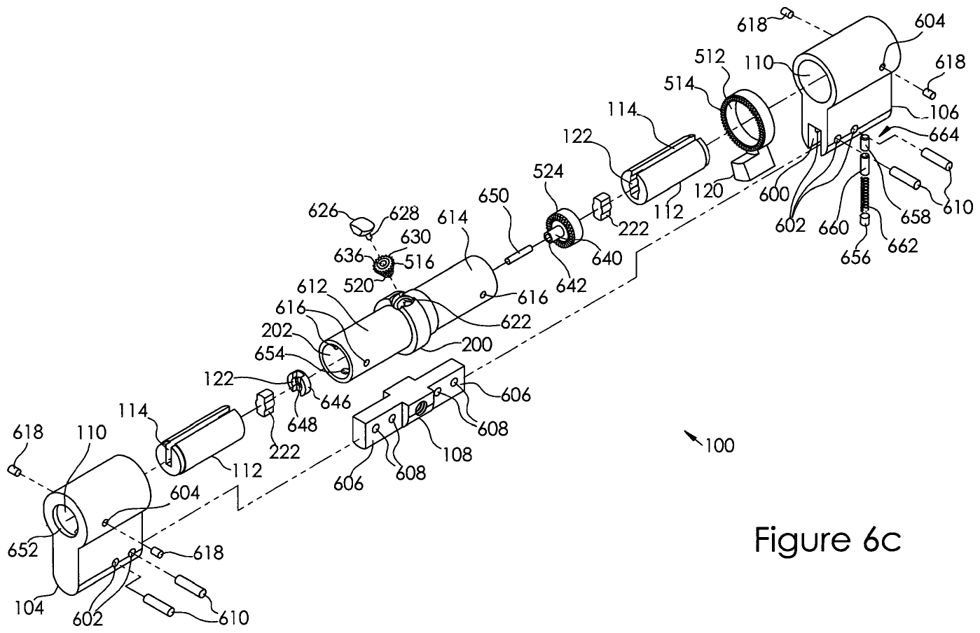

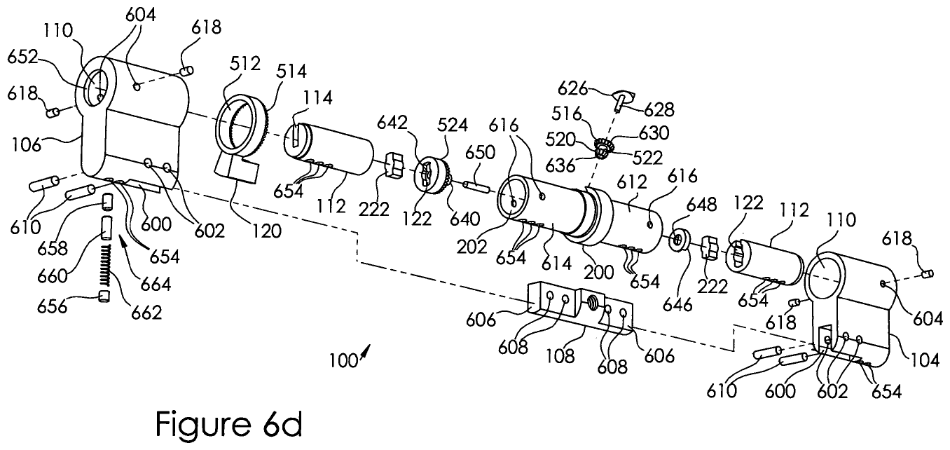

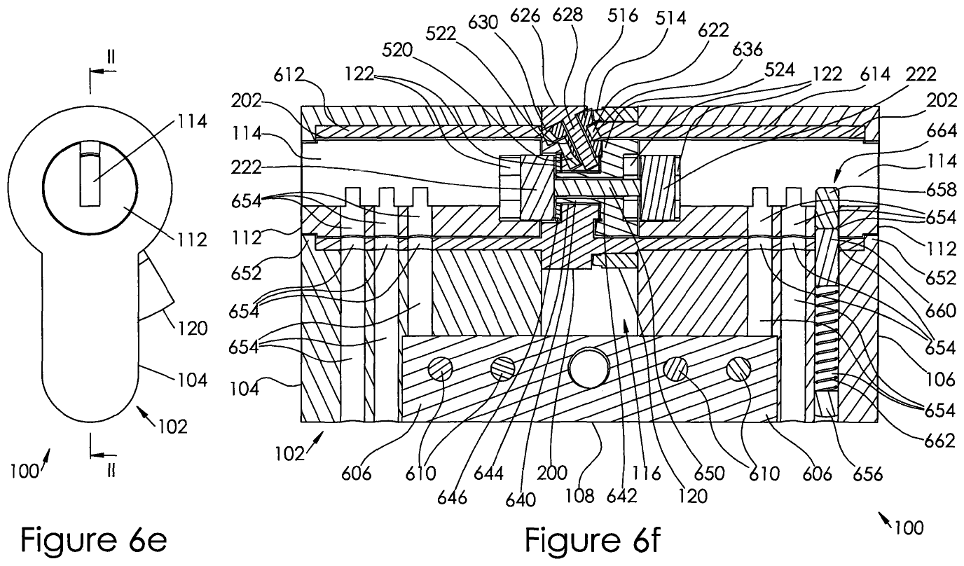

FIGS. 6a-f show a fifth cylinder lock of the present invention;

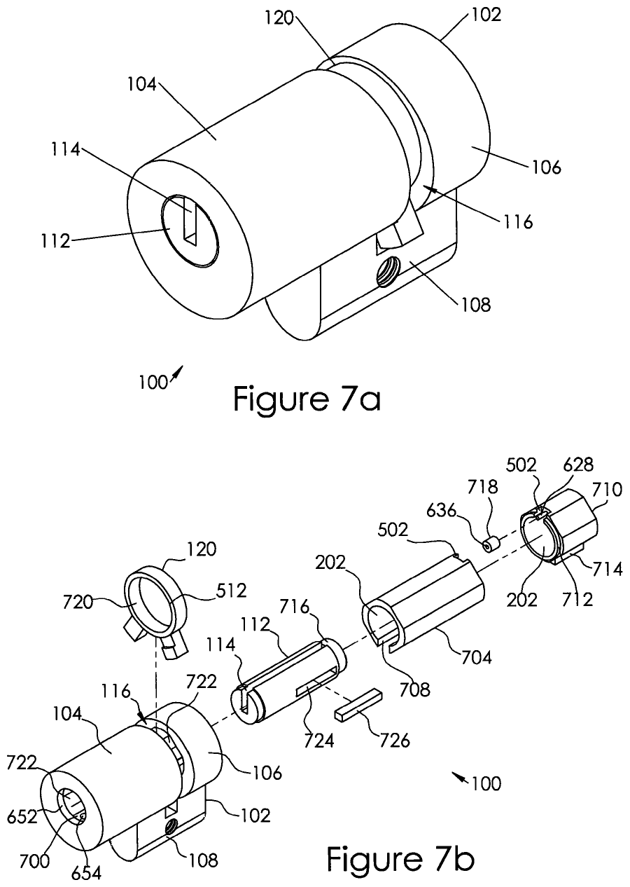

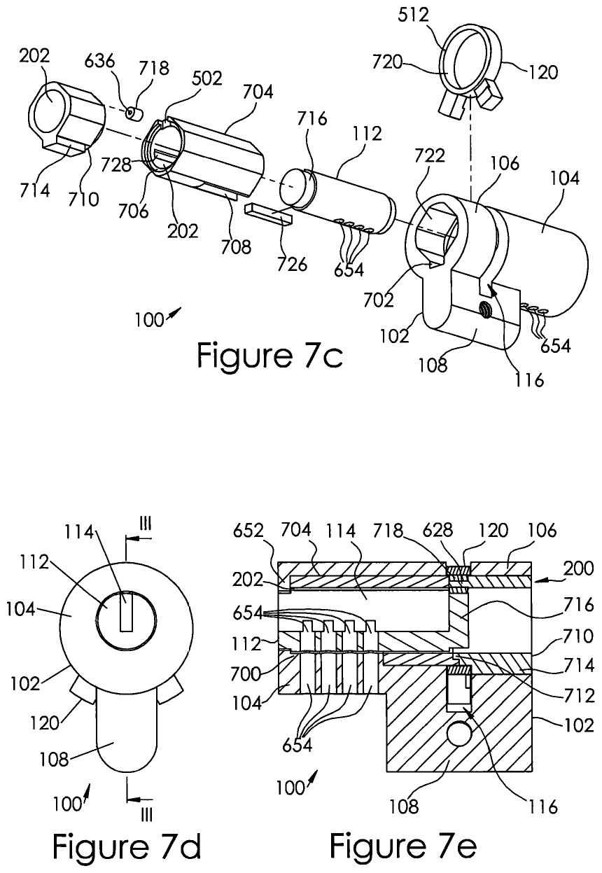

FIGS. 7a-e show a sixth cylinder lock of the present invention;

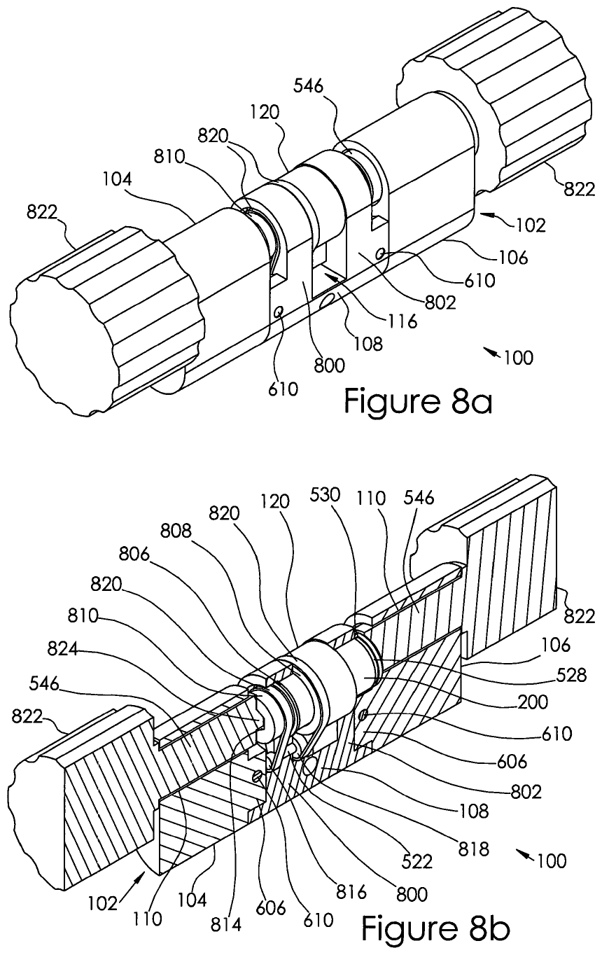

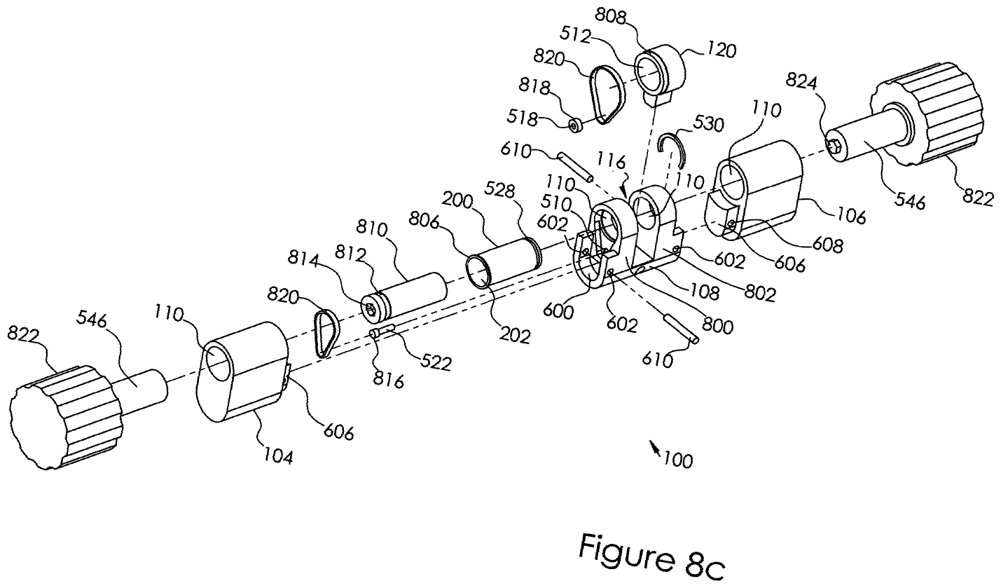

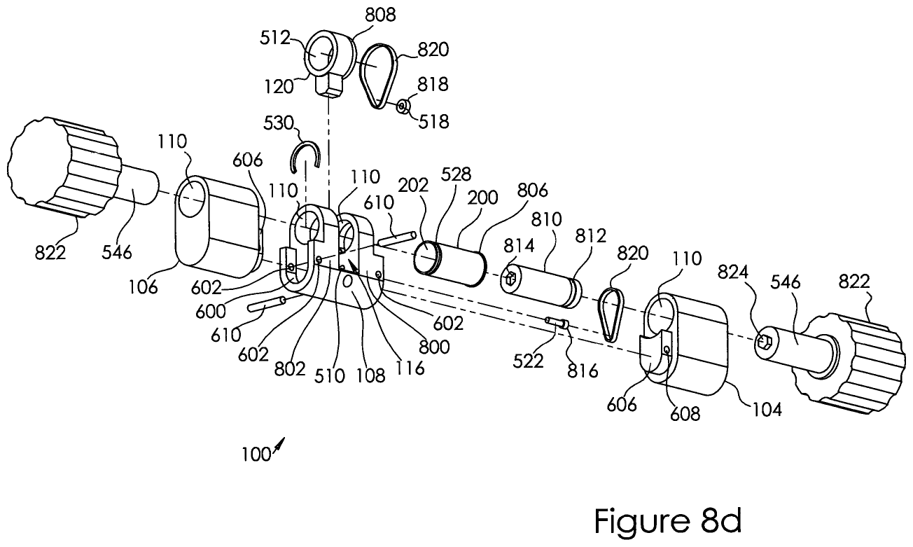

FIGS. 8a-d show a seventh cylinder lock of the present invention;

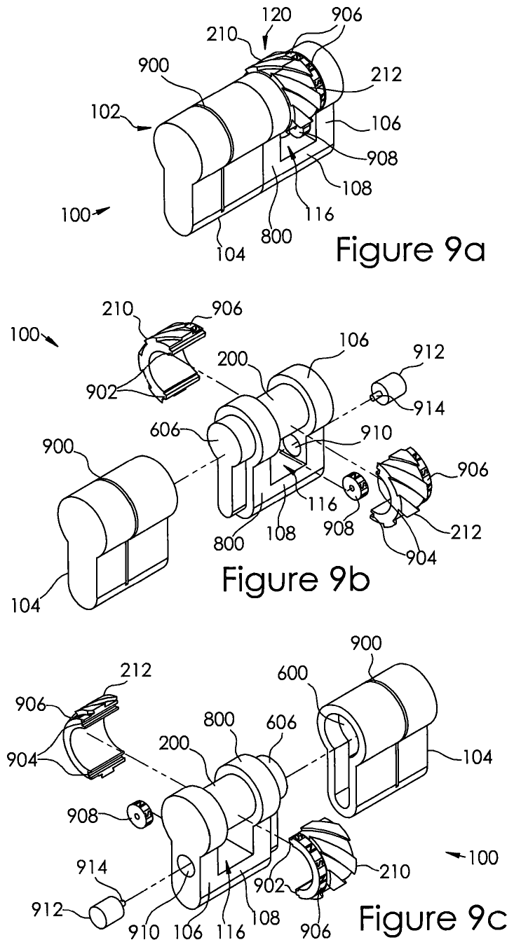

FIGS. 9a-c show an eighth cylinder lock of the present invention;

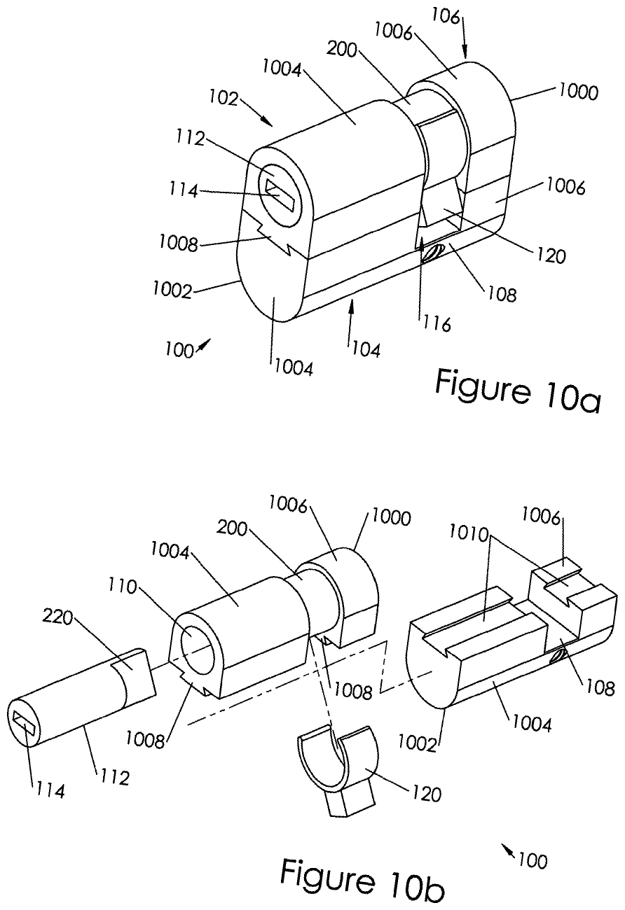

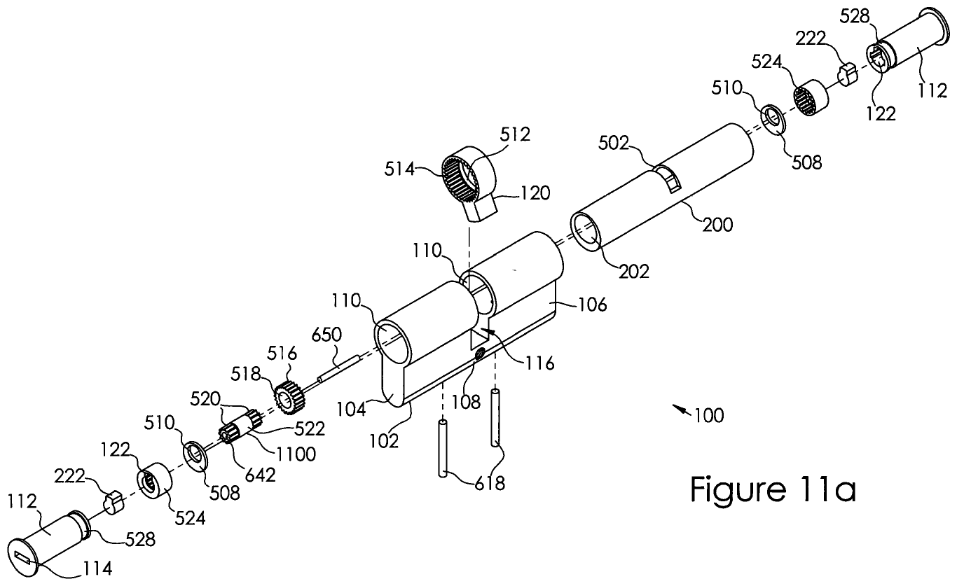

FIGS. 10a-b show a ninth cylinder lock of the present invention; and

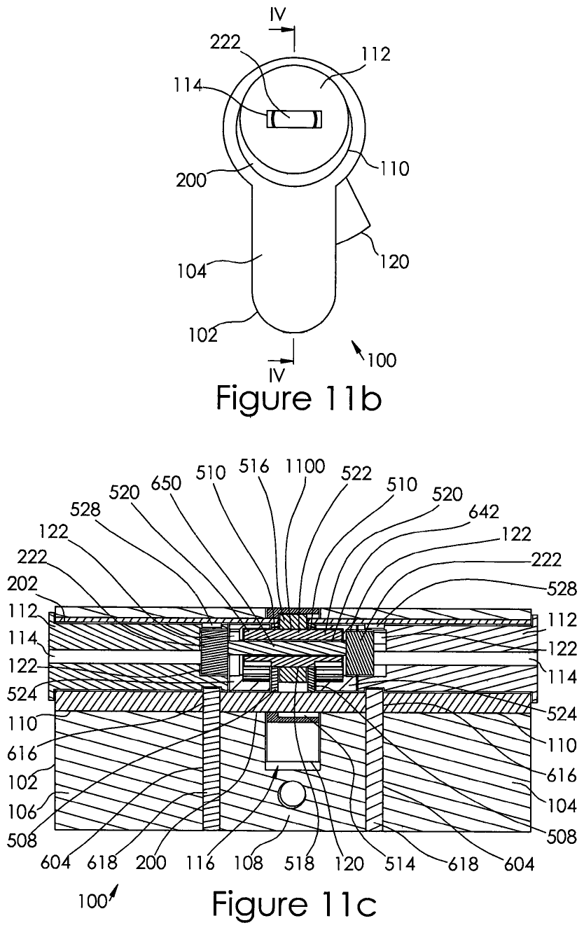

FIGS. 11a-c show a tenth cylinder lock of the present invention.

In the following description, similar parts in all the Figures have been given the same reference numerals in order to facilitate an easy comparison and understanding of equivalent component parts of the cylinder locks.

FIG. 1a shows a common cylinder lock 100 known as a double Euro cylinder. Such a cylinder lock usually has a housing 102 having a substantially uniform keyway-shaped profile with a first and a second housing side 104 and 106 connected by an integral central joining portion 108. An actuator 120 is positioned in a space 116 between the first and second housing sides 104 and 106. A cylindrical hole 110 in the first and second housing sides 104 and 106 seats a rotatable plug 112 comprising a keyway 114.

Various types of actuators 120 exist. FIG. 1c illustrates a prior art actuator 120 known as a cam and which comprises a camshaft and a cam lobe. The cam lobe of the actuator 120 radially extends from the outer surface of the camshaft. The actuator 120 may have more than one cam lobe. The actuator 120 of FIG. 1c has a clutch keyway 122 which may engage with a clutch component.

FIG. 1d illustrates another prior art actuator 120 known as a cog wheel or a gear, and which comprises a wheel and a plurality of projected cogs along the circumference of the wheel. The actuator 120 of FIG. 1d has a clutch keyway 122. The plug 112 may be rotationally coupled to the actuator 120 via a clutch arrangement.

One known drawback of these types of cylinder locks 100 is that they are prone to snapping when subjected to certain loads. It has become common for such locks 100 to be broken by intruders to provide access to manipulate the actuator 120.

The problem is inherent in the design. As is shown in FIG. 1a the joining portion 108 of the housing 102 contains a significantly reduced amount of material, creating a weak point. Typically a fixing hole that passes through the joining portion 108 is provided for securing the lock 100, leaving a very small amount of material above and below the fixing hole, and thereby further weakening the joining portion 108.

FIG. 1b shows the same prior art cylinder lock 100 after it has been snapped at the joining portion 108.

FIGS. 2a-d illustrate a first embodiment of the invention. FIG. 2a illustrates an isometric projection view of a cylinder lock 100. FIG. 2b illustrates an exploded isometric projection of the lock 100. FIG. 2c illustrates a front view of the lock 100. FIG. 2d illustrates a section therethrough on the line I-I of FIG. 2c.

The lock 100 comprises a housing 102 having a substantially uniform keyway-shaped profile commonly known as a Euro cylinder. The housing 102 of the lock 100 is formed by a cylindrical portion, from the outer surface of which an extension portion integrally radially extends. The lock 100 can be operated from two sides and may also be known as a double Euro cylinder. The housing 102 comprises first and second housing sides 104 and 106. The first and second housing sides 104 and 106 are connected by an integral joining portion 108 and an integral connecting portion 200. The connecting portion 200 extends completely across a space 116 between the first and second housing sides 104 and 106. The connecting portion 200 is fixed with respect to the first and second housing sides 104 and 106.

A cylindrical hole 110 in the first and second housing sides 104 and 106 seats a rotatable plug 112 comprising a keyway 114 and clutch keyway 122. An annulus 206 is press fitted into a circular recess 204 of the first and second housing sides 104 and 106 to prevent axial movement of the plug 112.

A cylindrical bore 202 through the connecting portion 200 seats a rotatable cylinder magnet 208 which comprises a clutch keyway 122 at its circular ends. The cylinder magnet 208 is preferably diametrically magnetised.

An actuator 120 is formed by a first and a second actuator side 210 and 212 which are joined together by press fitting a join pin 214 of the first actuator side 210 into a join hole 216 of the second actuator side 212. The actuator 120 is shown as a cam actuator. A magnetic material 220 is seated in a seating recess 218 of the first actuator side 210 and is attracted by magnets. The actuator 120 is seated in the space 116 and is rotatably mounted about the connecting portion 200 in order to cause operation of locking means (not shown). The locking means may be a mechanical locking means or an electrical locking means. The mechanical locking means may be a lock bolt, lock bar, latch, hook, pawl, cam or lock case. The electrical locking means may be an electromagnetic device.

The cylinder magnet 208 and the magnetic material 220 are magnetically coupled due to magnetic attraction. Turning the cylinder magnet 208 thus turns the actuator 120. Thus the cylinder magnet 208 forms rotating means for rotating the actuator 120 about the connecting portion 200.

The clutch keyway 122 of the plug 112 seats a clutch element 222. The clutch element 222 is rotationally (but not axially) fixed to the clutch keyway 122 of the plug 112. A clutch spring 224 sits within the clutch keyway 122 of the cylinder magnet 208, and bears against the end of the clutch keyway 122 and an end of the clutch element 222, seated in the adjacent plug 112. The clutch spring 224 is a compression coil spring. However other types of spring may be used including a magnetic spring.

When a key (not shown) is fully inserted in the keyway 114 of one plug 112, the tip of its blade extends into the clutch keyway 122 of the plug 112 and makes contact with the end of the clutch element 222, moving the clutch element 222 axially towards the cylinder magnet 208 so that a portion of the clutch element 222 enters the opposing clutch keyway 122 of the cylinder magnet 208. This rotationally couples the plug 112 with the cylinder magnet 208. The plug 112 is thus rotationally coupled to the actuator 120.

The clutch spring 224 biases the clutch element 222 and clutch keyway 122 of the cylinder magnet 208 apart. Withdrawing a key from the keyway 114 pushes the clutch element 222 away from the clutch keyway 122 of the cylinder magnet 208 under the bias of the clutch spring 224, decoupling the plug 112 and cylinder magnet 208. The clutch element 222 and the clutch keyway 122 form clutch means for the actuator 120. The clutch means may alternatively be another type of clutch arrangement.

The connecting portion 200 provides increased strength between the first and second housing sides 104 and 106, providing the lock 100 with greater resistance to snapping. The power to operate the lock 100 may be provided by an operator of the lock 100 when turning a key inserted in the keyway 114.

In one alternative modification, the magnetic material 220 may be replaced with a magnet. In another alternative modification, the cylinder magnet 208 may be replaced with a component that is made of a material attracted by magnets, and the magnetic material 220 may be replaced with a magnet. In a further alternative modification, the first or second actuator side 210 or 212 may be made of a magnet material or a material attracted by magnets, and the magnetic material 220 may be omitted. Other alternate variations may also be used to achieve a similar result.

A second embodiment of the invention is illustrated in FIG. 3. FIG. 3 illustrates a side view of a cylinder lock 100.

The lock 100 has a housing 102 comprising first and second housing sides 104 and 106 which are connected by an integral joining portion 108 and an integral connecting portion 200. The connecting portion 200 extends completely across a space 116 between the first and second housing sides 104 and 106.

A cylindrical hole 110 in the first housing side 104 seats a rotatable plug 112 comprising a keyway 114 and an integral drive gear 300.

An actuator 120 in the form of a cam actuator and comprising a driven gear 302 positioned in the space 116, is rotatably mounted on the connecting portion 200. The drive gear 300 is meshed with the driven gear 302 such that rotation of one will transmit rotation to the other. Rotation of the plug 112 will thus rotate the actuator 120. The drive gear 300 and the driven gear 302 thus form rotating means for rotating the actuator 120.

The drive and driven gears 300 and 302 may be of any type such as spur, helical, bevel or magnetic. In an alternative modification, planetary gears may be used. In an alternative modification, the drive and driven gears 300 and 302 may be replaced with wheels which transmit rotation by friction.

A third embodiment of the invention is illustrated in FIG. 4. FIG. 4 illustrates a side view of a cylinder lock 100.

The lock 100 has a housing 102 comprising a first and a second housing side 104 and 106 which are connected by an integral connecting portion 200. The connecting portion 200 extends completely across a space 116 between the first and second housing sides 104 and 106.

A cylindrical hole 110 in the first housing side 104 seats a rotatable plug 112 comprising a keyway 114 and an integral drive sprocket 400.

An actuator 120 in the form of a cam actuator and comprising a driven sprocket 402 seated in the space 116, is rotatably mounted on the connecting portion 200. A chain 404 connects the drive sprocket 400 and driven sprocket 402 so that rotation of either the drive or driven sprocket 400 or 402 will transmit rotation to the other. The chain 404 provides coupling means to couple the drive sprocket 400 and driven sprocket 402. Rotation of the plug 112 will thus rotate the actuator 120. The drive sprocket 400, driven sprocket 402 and chain 404 thus form rotating means for rotating the actuator 120 about the connecting portion 200.

In another embodiment, the rotating means in the form of the drive or driven sprocket 400 or 402 may be replaced with a pulley or other device. The chain 404 may be replaced with other coupling means such for example as a belt, wire, cable, rope, band or other device. In an alternative modification, the lock 100 may comprise a joining portion between the first and second housing sides 104 and 106.

A fourth embodiment of the invention is illustrated in FIGS. 5a-d. FIG. 5a illustrates an isometric projection view of a lock 100. FIGS. 5b and 5c illustrate an exploded projection of the lock 100. FIG. 5d illustrates an isometric projection cutaway view of the lock 100.

The lock 100 comprises a housing 102 with a profile shape that is two semicircles joined by a rectangle. Such a lock 100 is commonly known as an oval cylinder. The housing 102 comprises first and second housing sides 104 and 106 which are connected by an integral joining portion 108.

The first and second housing sides 104 and 106 comprise a fixing hole 504. A threaded fastener 506 in the form of a bolt extends through the fixing hole 504 and screws into a threaded hole 500 of the connecting portion 200 to fasten the first and second housing sides 104 and 106 to the connecting portion 200. The threaded fastener 506 provides joining means to join the connecting portion 200 to the first and second housing sides 104 and 106. Other fasteners may be used to provide joining means, for example a rivet, a pin, a screw, a clip or a retaining ring. Other joining means may be employed such as crimping, an adhesive, welding, brazing or soldering. The connecting portion 200 extends completely across a space 116 between the first and second housing sides 104 and 106.

The connecting portion 200 comprises a cylindrical bore 202 and a circumferential slot 502 on its curved surface. An actuator 120 in the form of a cog wheel actuator is positioned in the space 116 and rotatably mounted on the connecting portion 200. The actuator 120 comprises a hole 512 and an integral second stage gear 514 formed by an internal gear. A second stage pinion 516 comprising a shaft coupling hole 518 is housed by the cylindrical bore 202 such that it partially protrudes from the circumferential slot 502 of the connecting portion 200, and meshes with the second stage gear 514 of the actuator 120.

A disc member 508 comprising a shaft bearing hole 510 is seated on each side of the second stage pinion 516 in the cylindrical bore 202. The shaft coupling hole 518 of the second stage pinion 516 is concentric with the shaft bearing hole 510 of the disc member 508.

A first stage pinion 520 comprising an axially projecting coupling shaft 522 is located beside each disc member 508. The coupling shaft 522 of the first stage pinion 520 is rotatably mounted in the shaft bearing hole 510 of the disc member 508 and press-fitted in the shaft coupling hole 518 of the second stage pinion 516 so that the first stage pinions 520 and second stage pinion 516 are fixed.

A first stage gear 524 formed by an internal gear is rotatably mounted in each side of the cylindrical bore 202 of the connecting portion 200. Each first stage gear 524 is meshed with a first stage pinion 520. Rotation of a first stage gear 524 transmits rotation to the meshed first stage pinion 520, thus rotating the second stage pinion 516 fixed to it. The second stage pinion 516 transmits rotation to the meshed second stage gear 514 to rotate the actuator 120. The first stage gear 524, first stage pinion 520, second stage pinion 516 and second stage gear 514 thus form rotating means for rotating the actuator 120 about the connecting portion 200. In this embodiment, the arrangement and number of gear teeth of the first stage gear 524, first stage pinion 520, second stage pinion 516 and second stage gear 514 are configured so that the first stage gear 524 and actuator 120 rotate equally and in the same direction. Other configurations may be used to achieve a same or different result. There may be additional or fewer gears or gear stages in an alternative modification.

A cylindrical hole 110 in the first housing side 104 seats a rotatable plug 112 having a keyway 114, a circumferential groove 528 and a clutch disc seating 532 which comprises an axial slot 534. A retaining ring 530 is seated on the circumferential groove 528 of the plug 112. The retaining ring 530 restricts axial movement of the plug 112.

A clutch disc 536 comprising a radially projecting tab 538, a transmission slot 540 and a clutch spring seating 542 is seated in the clutch disc seating 532 of the plug 112. The tab 538 of the clutch disc 536 is seated in the axial slot 534 of the clutch disc seating 532 so that the clutch disc 536 is rotationally (but not axially) coupled to the plug 112.

A clutch spring 224 is seated in the clutch spring seating 542 of the clutch disc 536, and bears against the end of the clutch spring seating 542 and the adjacent first stage gear 524.

When a key is fully inserted in the keyway 114 of the plug 112, it makes contact with the end of the clutch disc 536, moving the clutch disc 536 axially towards the adjacent first stage gear 524 so that a transmission pin 526 of the first stage gear 524 can enter the transmission slot 540 of the clutch disc 536. This rotationally couples the clutch disc 536 with the first stage gear 524. Thus rotation of the plug 112 will rotate the actuator 120.

The transmission pin 526 is slidable in the transmission slot 540 to allow rotational coupling of the clutch disc 536 and adjacent first stage gear 524, although their axes are not collinear. In an alternative modification, other types of couplings such as an Oldham coupling may be used in place of the transmission pin 526 and transmission slot 540 to transmit rotation between non-collinear axes.

Withdrawing a key from the keyway 114, pushes the clutch disc 536 away from the adjacent first stage gear 524 under the bias of the clutch spring 224, disengaging the transmission pin 526 from the adjacent transmission slot 540. The plug 112 and actuator 120 are then no longer rotationally connected. The transmission pin 526 and the transmission slot 540 provide clutch means for the actuator 120.

A turnable control device in the form of a thumb turn 544, designed to be turned by a thumb and finger of an operator, comprises an axially projected turn shaft 546 with a transmission slot 540 at its end. The turn shaft 546 of the thumb turn 544 is rotatably mounted in the cylindrical hole 110 of the second housing side 106. A retaining ring 530 is seated on a circumferential groove 528 of the turn shaft 546.

The transmission pin 526 of the first stage gear 524 that is adjacent to the turn shaft 546 is slidable in the transmission slot 540 of the turn shaft 546. This rotationally couples the thumb turn 544 with the first stage gear 524, thereby rotationally connecting the thumb turn 544 with the actuator 120. In this embodiment, the rotating means is configured so that rotation of the plug 112 or turnable control device provides equal rotation of the actuator 120. The rotating means is configured so that one revolution of the plug 112 or turnable control device will provide one revolution of the actuator 120. The rotating means is also configured so that rotation of the plug 112 or turnable control device rotates the actuator 120 in the same direction.

FIGS. 6a-f illustrate a fifth embodiment of the present invention. FIG. 6a illustrates an isometric projection of a lock 100. FIG. 6b illustrates a projection cutaway view of the lock 100. FIGS. 6c and 6d illustrate an exploded projection of the lock 100. FIG. 6e illustrates a front view of the lock 100. FIG. 6f illustrates a section therethrough on the line Il-Il of FIG. 6e.

The lock 100 comprises a multicomponent housing 102 with first and second housing sides 104 and 106 joined by a joining portion 108. The first and second housing sides 104 and 106 comprise a cylindrical hole 110, a mortice 600, attachment holes 602 and fastening holes 604. The joining portion 108 comprises a tenon 606 at each end, and attachment bores 608 through each tenon 606.

The tenons 606 of the joining portion 108 insert into the mortices 600 of the first and second housing sides 104 and 106. The attachment bores 608 of the tenon 606 may be aligned with the corresponding attachment holes 602 of the first and second housing sides 104 and 106. An attachment pin 610 that extends through the attachment holes 602 and corresponding attachment bores 608 may be used to secure the first and second housing sides 104 and 106 to the joining portion 108. There is a space 116 between the first and second housing sides 104 and 106.

A connecting portion 200 provides another connection between the first and second housing sides 104 and 106. The connecting portion 200 comprises first and second minor cylinders 612 and 614 having a cylindrical bore 202 and fastening bores 616. The first and second minor cylinders 612 and 614 of the connecting portion 200 insert into the cylindrical hole 110 of the first and second housing sides 104 and 106 respectively. The first and second minor cylinders 612 and 614 of the connecting portion 200 provide extending portions which extend into the cylindrical hole 110 of the first and second housing sides 104 and 106 to facilitate attachment of the extending portion in the housing components. There may be an interference or other type of fit between the cylindrical holes 110 and the first and second minor cylinders 612 and 614 in order to provide joining means to join the first and second housing sides 104 and 106 to the connecting portion 200.

The fastening bores 616 of the first and second minor cylinders 612 and 614 may be aligned with the corresponding fastening holes 604 of the first and second housing sides 104 and 106. A fastening pin 618 that extends through the fastening holes 604 and corresponding fastening bores 616 may join the first and second housing sides 104 and 106 to the connecting portion 200.

The joining portion 108 and connecting portion 200 may be joined to the first and second housing sides 104 and 106 by other joining means such for example as crimping, screwing, riveting, a clip, a retaining ring, welding, brazing, soldering or an adhesive.

A plug 112 comprising a keyway 114 and a clutch keyway 122 is rotatably mounted in the cylindrical bore 202 of the first and second minor cylinders 612 and 614. A retaining flange 652 of the first and second housing sides 104 and 106 restricts axial movement of the plugs 112.

An actuator 120 in the form of a cam actuator is rotatably mounted on the connecting portion 200 and is seated in a space 116 between the first and second housing sides 104 and 106. The actuator 120 comprises a hole 512 and an integral second stage gear 514 in the form of a bevel gear. The connecting portion 200 comprises a pinion set seating cavity 622 formed by varying diameter bores.

An integrally formed pinion set 630 comprises a second stage pinion 516 in the form of a bevel gear, and a first stage pinion 520 in the form of a bevel gear joined by a coupling shaft 522. A pivot hole 636 passes axially through the pinion set 630. The pinion set 630 is seated in the pinion set seating cavity 622 of the connection portion 200.

A pinion seating cover 626 comprising a pivot pin 628 is a press-fit at the opening of the pinion set seating cavity 622. The pivot pin 628 is secured to the base of the pinion set seating cavity 622. The pivot pin 628 passes through the pivot hole 636 of the pinion set 630 so that the pinion set 630 is rotatable about the pivot pin 628.

A first stage gear 524 in the form of a bevel gear is housed within the connecting portion 200 and comprises an axially projecting transmission shaft 640, a clutch keyway 122 and a clutch rod seating hole 642. The transmission shaft 640 of the first stage gear 524 extends through and is rotatably mounted in a pivot bore 644 of the connecting portion 200.

The first stage gear 524 is meshed with the first stage pinion 520 of the pinion set 630, and the second stage gear 514 of the actuator 120 is meshed with the second stage pinion 516 of the pinion set 630. Thereby rotation of the first stage gear 524 will rotate the actuator 120. The first stage gear 524, first stage pinion 520, second stage pinion 516 and second stage gear 514 thus form rotating means for rotating the actuator 120. The first stage gear 524, first stage pinion 520, second stage pinion 516 and second stage gear 514 are configured so that the first stage gear 524 and the actuator 120 rotate equally in the same direction.

A transmission disc 646 comprising a clutch keyway 122 and a shaft connecting hole 648 is fixed to the first stage gear 524 by press-fitting the end of the transmission shaft 640 of the first stage gear 524 into the shaft connecting hole 648 of the transmission disc 646 so that they are rotationally and axially fixed.

The clutch keyway 122 of the plugs 112 seat a clutch element 222 which is rotationally (but not axially) fixed to the clutch keyway 122.

When a key is inserted in the keyway 114 of the plug 112 mounted in the cylindrical bore 202 of the first minor cylinder 612, the tip of its blade makes contact with the end of the clutch element 222 seated in the clutch keyway 122 of the plug 112, moving the clutch element 222 axially towards the transmission disc 646. A portion of the clutch element 222 thus enters the opposing clutch keyway 122 of the transmission disc 646, rotationally coupling the plug 112 with the first stage gear 524. Thereby rotation of the plug 112 will rotate the actuator 120.

A clutch rod 650 is slidably seated in the clutch rod seating hole 642 of the first stage gear 524 so that it can move axially and is located between the clutch elements 222. When the clutch element 222 seated in the clutch keyway 122 of the plug 112 mounted in the cylindrical bore 202 of the first minor cylinder 612 moves into the clutch keyway 122 of the transmission disc 646, it may push the clutch rod 650 axially. This may move the clutch element 222 seated in the clutch keyway 122 of the plug 112 mounted in the cylindrical bore 202 of the second minor cylinder 614 away from the clutch keyway 122 of the first stage gear 524, thereby decoupling the plug 112 of the second minor cylinder 614 from the first stage gear 524.

Inversely, if a key is fully inserted in the keyway 114 of the plug 112 mounted in the cylindrical bore 202 of the second minor cylinder 614, the plug 112 will be rotationally coupled to the first stage gear 524 whilst the plug 112 mounted in the cylindrical bore 202 of the first minor cylinder 612 will be rotationally decoupled from the first stage gear 524. The clutch element 222 and the clutch keyway 122 form clutch means for the actuator 120.

In this embodiment, the rotating means is configured so that rotation of the plug 112 provides equal rotation of the actuator 120. The rotating means is configured so that one revolution of the plug 112 will provide one revolution of the actuator 120. The rotating means is also configured so that rotation of the plug 112 rotates the actuator 120 in the same direction.

FIGS. 6a-f illustrate the lock 100 where the clutch element 222 seated in the clutch keyway 122 of the plug 112 mounted in the cylindrical bore 202 of the first minor cylinder 612 is partially seated the clutch keyway 122 of the transmission disc 646.

To accommodate a pin tumbler lock mechanism, the first and second housing sides 104 and 106, the connecting portion 200 and the plugs 112 comprise pin tumbler holes 654. The pin tumbler holes 654 of the components may align axially.

Each aligned set of pin tumbler holes 654 may seat a pin stack 664 comprising locking components in the form of a key pin 658 and a driver pin 660. A pin stack 664 may contain additional pins or other locking components. The illustrated lock 100 in FIGS. 6a-f shows a single pin stack 664 seated in an aligned set of pin tumbler holes 654. However preferably the lock 100 may comprise multiple pin stacks 664.

A stack spring 662 placed adjacent to the driver pin 660 biases the pin stack 664 towards the plug 112. A cap 656 is fixed in an end of the pin tumbler hole 654 of the second housing side 106 that seats the pin stack 664.

The pin tumbler holes 654, pin stack 664 and stack spring 662 provide a pin tumbler lock mechanism. At rest a portion of the driver pin 660 seats in the pin tumbler hole 654 of both the connecting portion 200 and plug 112. Thereby the plug 112 is rotationally locked to the connecting portion 200.

Insertion of a correct key in the keyway 114 moves the pin stack 664 so that the driver pin 660 does not lock the plug 112 relative to the connecting portion 200. Insertion of an incorrect key may move the key pin 658 so that it partly seats in the pin tumbler hole 654 of both the connecting portion 200 and plug 112, locking the plug 112 relative to the connecting portion 200. The pin tumbler holes 654 of the connecting portion 200 provide a receiving portion for receiving a locking component.

In an alternative modification the lock 100 may accommodate a different lock mechanism. The pin tumbler holes 654 may be replaced with other features such as a slot, groove, notch or depression, and the pin stack 664 may be replaced with other locking components such as a bar, ball, catch, wafer or disc.

In another embodiment the plug 112 may be replaced with a turnable control device which may be rotationally lockable to the connecting portion 200.

In the illustrated embodiment, there is a single pinion set 630 to transmit torque. An alternative modification may have a plurality of pinon sets 630 to share the load. Thereby, torque capability may be increased.

In the illustrated embodiment, the first and second minor cylinders 612 and 614 extend the length of the cylindrical hole 110 of the first and second housing sides 104 and 106. However the first and second minor cylinders 612 and 614 may be of a different length to the cylindrical hole 110.

Increasing the length by which the first and second minor cylinders 612 and 614 extend into the first and second housing sides 104 and 106 may increase resistance to bending forces because the force is distributed along a greater length. It may reduce the tendency of the walls of the cylindrical hole 110 and the first and second minor cylinders 612 and 614 to deform or fracture.

FIGS. 7a-e illustrate a sixth embodiment of the invention. FIG. 7a illustrates an isometric projection of a lock 100. FIGS. 7b and 7c illustrate an exploded projection of the lock 100. FIG. 7d illustrates a front view of the lock 100. FIG. 7e illustrates a section therethrough on the line of FIG. 7d.

The lock 100 comprises a housing 102 with a Swiss round profile which can be operated from one side. The lock 100 is commonly known as a Swiss round. The housing 102 comprises first and second housing sides 104 and 106 which are connected by an integral joining portion 108. The first housing side 104 comprises a rounded square hole 722 having a longitudinal spline 700. The second housing side 106 comprises a rounded square hole 722 having an axial groove 702.

A connecting portion 200 having a rounded square form comprises first and second connecting portion sides 704 and 710. The first connecting portion side 704 comprises a joining bore 706, a longitudinal slot 708 and a circumferential slot 502. The second connecting portion side 710 comprises a joining rim 712, an axial spline 714, a circumferential slot 502 and an integral pivot pin 628.

The joining rim 712 fits inside the joining bore 706 to join the first and second connecting portion sides 704 and 710 which together form the connecting portion 200. A strong join may be created between the first and second connecting portion sides 704 and 710 by an interference fit, welding, brazing, an adhesive, or other means. Alternatively a fastening means may be used such for example as a screw, pin, rivet or clip.

The connecting portion 200 has extending portions which extend into the first and second housing sides 104 and 106 to facilitate attachment of the extending portions to the housing components. The connecting portion 200 fits into the rounded square hole 722 of the first and second housing sides 104 and 106. The longitudinal spline 700 of the first housing side 104 fits into the longitudinal slot 708 of the first connecting portion side 704, and the axial spline 714 of the second connecting portion side 710 fits into the axial groove 702 of the second housing side 106. There may be an interference fit, or other fit between the connecting portion 200 and the rounded square hole 722.

A plug 112 comprising a keyway 114 and an integral drive wheel 716 is rotatably mounted in the cylindrical bore 202 of the first connecting portion side 704. A retaining flange 652 of the first housing side 104 prevents removal of the plug 112 from the front of the lock 100.

An intermediate wheel 718 comprising a pivot hole 636 is rotatably seated on the pivot pin 628 of second connecting portion side 710, and partially protrudes through the circumferential slot 502.

An actuator 120 in the form of a cam actuator comprises a hole 512 and two cam lobes. The inner surface of the hole 512 forms a driven wheel 720. The actuator 120 is positioned in a space 116 and is rotatably mounted on the connecting portion 200. The intermediate wheel 718 is in contact with the drive wheel 716 of the plug 112 and the driven wheel 720 of the actuator 120. The drive wheel 716 can transmit rotation to the intermediate wheel 718 by the friction between them. The intermediate wheel 718 can transmit rotation to the driven wheel 720 by the friction between them. Thus rotating the plug 112 will rotate the actuator 120. The drive wheel 716, intermediate wheel 718 and driven wheel 720 thus form rotating means for rotating the actuator 120.

To accommodate a pin tumbler lock mechanism, the first housing side 104 and the plug 112 comprise pin tumbler holes 654. The longitudinal slot 708 of the connecting portion 200 provides clearance for the pin tumbler holes 654.

The pin tumbler holes 654 of the first housing side 104 and the plug 112 may seat a pin stack (not shown). The pin stacks may rotationally lock the plug 112 to the housing 102 when a correct key is not inserted in the keyway 114. Inserting a correct key in the keyway 114 may move the pin stacks so that the plug 112 is not rotationally locked to the housing 102.

In an alternative embodiment, the connecting portion 200 and other components of the lock 100 may have other features such for example as holes, slots, grooves, notches or depressions to accommodate other types of lock mechanism.

In the illustrated embodiment, there is a single intermediate wheel 718 to transmit torque. An alternative modification may comprise a plurality of intermediate wheels 718 to share the load, whereby torque capability may be increased.

A locking component in the form of a side bar 726 is seated in a side bar seating 724 of the plug 112. Normally the side bar 726 protrudes from the side bar seating 724 and extends into a locking groove 728 of the connecting portion 200, thus rotationally locking the plug 112 relative to the connecting portion 200. Without a correct key inserted in the keyway 114, the side bar 726 is prevented from retracting into the side bar seating 724.

When a correct key is inserted in the keyway 114, the side bar 726 may retract into the side bar seating 724, and withdraw out of the locking groove 728 to unlock the plug 112 relative to the connecting portion 200. The side bar 726, side bar seating 724 and locking groove 728 provide a side bar locking mechanism. The locking groove 728 of the connecting portion 200 provides a receiving portion for receiving a locking component. In an alternative modification, the receiving portion may be a slot, notch, depression or hole, and the side bar 726 may be replaced with other locking components such as a pin, ball, catch, wafer or disc.

FIGS. 8a-d illustrate a seventh embodiment of the invention. FIG. 8a illustrates an isometric projection view of a lock 100. FIG. 8b illustrates an isometric projection cutaway view of the lock 100. FIGS. 8c and 8d illustrate an exploded projection of the lock 100.

The lock 100 comprises a housing 102 with first and second housing sides 104 and 106, first and second housing extensions 800 and 802, and a joining portion 108. The first and second housing extensions 800 and 802 and the joining portion 108 are integrally formed.

The first and second housing sides 104 and 106 comprise a tenon 606 and an attachment bore 608. The first and second housing extensions 800 and 802 comprise a mortice 600 at their end and attachment holes 602.

The tenons 606 of the first and second housing sides 104 and 106 insert into the mortices 600 of the first and second housing extensions 800 and 802 respectively. The attachment bore 608 aligns with the corresponding attachment holes 602. An attachment pin 610 that extends through the attachment holes 602 and corresponding attachment bore 608 may be used to secure the first and second housing sides 104 and 106 to the first and second housing extensions 800 and 802 respectively. Thereby the joining portion 108 provides a join between the first and second housing sides 104 and 106.

The first and second housing extensions 800 and 802 comprise a cylindrical hole 110. A connecting portion 200 comprises a cylindrical bore 202, an external flange 806 at one end and a circumferential groove 528 at the other. Portions of the connecting portion 200 are seated in the cylindrical hole 110 of the first and second housing extensions 800 and 802.

The connecting portion 200 has extending portions which extend into the first and second housing extensions 800 and 802 to facilitate attachment of the extending portions to the housing components.

A retaining ring 530 is seated on the circumferential groove 528 of the connecting portion 200. The external flange 806 interferes with the first housing extension 800 and the retaining ring 530 interferes with the second housing extension 802 to secure the connecting portion 200 and constrain its axial movement. The external flange 806 and retaining ring 530 provide joining means to join the connection portion 200 to housing components. The connecting portion 200 connects the first and second housing extensions 800 and 802, whereby it connects the first and second housing sides 104 and 106.

A space 116 between the first and second housing extensions 800 and 802 seats an actuator 120. The first and second housing extensions 800 and 802 are positioned between the first and second housing sides 104 and 106. Therefore the space 116 is positioned between the first and second housing sides 104 and 106. The connecting portion 200 extends completely across the space 116.

The actuator 120 which comprises a hole 512 and an integral driven pulley 808 is rotatably mounted about the connecting portion 200. A transmission cylinder 810 comprising a hexagonal hole 814 at each end and a drive pulley 812 is rotatably mounted in a cylindrical bore 202 of the connecting portion 200.

A first intermediate pulley 816 comprises a coupling shaft 522 which extends through and is rotatably mounted in a shaft bearing hole 510 of the first housing extension 800. A second intermediate pulley 818 comprising a shaft coupling hole 518 is fixed to the coupling shaft 522 of the first intermediate pulley 816 by press fitting the end of the coupling shaft 522 into the shaft coupling hole 518 so that they are rotationally coupled.

A belt 820 couples the drive pulley 812 and first intermediate pulley 816. Another belt 820 couples the second intermediate pulley 818 to the driven pulley 808. The belts 820 provide coupling means. Rotating the transmission cylinder 810 and thereby the drive pulley 812, transmits rotary motion to the first intermediate pulley 816 via the belt 820 which couples them. The coupling shaft 522 transmits rotation to the second intermediate pulley 818, which transmits rotary motion to the driven pulley 808 via the belt 820 which couples them.

The drive pulley 812, first intermediate pulley 816, second intermediate pulley 818, driven pulley 808 and the two illustrated belts 820 thus form rotating means for rotating the actuator 120 about the connecting portion 200.

The drive pulley 812, first intermediate pulley 816, second intermediate pulley 818, driven pulley 808 and the belts 820 may comprise teeth to aid power transmission and eliminate slippage between the pulleys and belts 820.

A turnable control device in the form of a knob 822 shaped to facilitate gripping and turning by an operator, comprises an axially projecting turn shaft 546 and a hexagonal shaft 824. A knob 822 is mounted on each side of the lock 100. The turn shafts 546 of the knobs 822 are rotatably mounted in the cylindrical holes 110 of the first and second housing sides 104 and 106. The turnable control device may be rotated by an operator of the lock 100 to provide power to operate the lock 100.

The hexagonal shaft 824 of each knob 822 is a press-fit into the adjacent hexagonal hole 814 of the transmission cylinder 810 to fix the knobs 822 to the transmission cylinder 810. Thus rotating either knob 822 rotates the actuator 120. The diameters of the drive pulley 812, first intermediate pulley 816, second intermediate pulley 818 and driven pulley 808 of the rotating means are configured so that rotation of the turnable control device provides equal rotation of the actuator 120. The rotating means is configured so that one revolution of the turnable control device will provide one revolution of the actuator 120. The rotating means is also configured so that rotation of the turnable control device rotates the actuator 120 in the same direction.

Such a lock 100 may comprise electronic authentication means to authenticate an operator. After authentication, a lock mechanism may move a locking component to permit the knob 822 to be turned by the operator. The electronic authentication means may for example be a key, fob, card, remote, wireless device, security token, keypad to enter code or biometrics. In another embodiment the knob 822 may be replaced with a plug.

In the embodiments of the invention shown in FIGS. 6a-f, 7a-e and 8a-d, there is shown how the connecting portion 200 may include an extending portion, and in which the extending portion extends into housing components for facilitating attachment of the extending portion to the housing components.

FIGS. 9a-c illustrate an eighth embodiment of the invention. FIG. 9a illustrates an isometric projection of a lock 100. FIGS. 9b and 9c illustrate an exploded isometric projection of the lock 100.

The lock 100 comprises a housing 102 with first and second housing sides 104 and 106, a first housing extension 800, a joining portion 108, and a connecting portion 200. The first housing extension 800, joining portion 108, connecting portion 200 and second housing side 106 are integrally formed.

A tenon 606 of the first housing extension 800 inserts into a mortice 600 of the first housing side 104. An interference fit, adhesive, welding, a fastener or other means may be used to join the first housing side 104 to the first housing extension 800. Thereby the joining portion 108 and connecting portion 200 provide a joint between the first and second housing sides 104 and 106.

A weakening formation 900 provided by a slit in the first housing side 104 is designed to rupture when the first housing side 104 is subjected to loads, thereby shortening the length of the first housing side 104 and making it more difficult to grasp with a tool to apply further loads.

An actuator 120 in the form of a worm actuator comprises first and second actuator sides 210 and 212 which are joined together by press-fitting a join spline 902 of the first actuator side 210 into the corresponding join groove 904 of the second actuator side 212. The first and second actuator sides 210 and 212 may be joined by other means. The first and second actuator sides 210 and 212 comprise a magnetic gear track 906.

The magnetic gear track 906 of the first and second actuator sides 210 and 212 together form a continuous circular track. The actuator 120 is rotatably mounted on the connecting portion 200.

The second housing side 106 comprises a motor seating hole 910 which seats a motor 912 comprising a motor shaft 914. A magnetic gear 908 is fixed to the motor shaft 914 so that the motor 912 can rotate the magnetic gear 908.

The magnetic gear 908 can transmit torque to the magnetic gear track 906 of the actuator 120 so that rotation of the magnetic gear 908 transmits rotation to the magnetic gear track 906, thereby rotating the actuator 120. The magnetic gear 908 and magnetic gear track 906 form rotating means for rotating the actuator 120.

Such a lock 100 may comprise electronic authentication means to authenticate an authorised operator, and upon successful authentication activate the motor 912 to rotate the actuator 120. The power to operate the lock 100 is provided by the motor 912.

In an alternative modification, the join between the first housing side 104 and first housing extension 800 may release to allow the first housing side 104 to separate from the first housing extension 800 when the first housing side 104 is subjected to predetermined loads. This makes it difficult to grasp the remaining portion of the housing 102 with a tool to apply further loads.

Another embodiment of the invention is illustrated in FIGS. 10a and 10b. FIG. 10a illustrates an isometric projection of a lock 100. FIG. 10b illustrates an exploded isometric projection of the lock 100.

The lock 100 has a housing 102 which comprises top and bottom housing sections 1000 and 1002. The top housing section 1000 is integrally formed with first and second housing side sections 1004 and 1006, which are joined by a connecting portion 200. The first and second housing side sections 1004 and 1006 of the top housing section 1000 comprise a dovetail spline 1008. The top housing section 1000 also comprises a cylindrical hole 110 which extends through the first housing side section 1004 and the connecting portion 200.

The bottom housing section 1002 is integrally formed with first and second housing side sections 1004 and 1006, which are joined by a joining portion 108. The first and second housing side sections 1004 and 1006 of the bottom housing section 1002 comprise a socket groove 1010.

The dovetail spline 1008 of the top housing section 1000 fits into the socket groove 1010 of the bottom housing section 1002, and interlocks to join the top and bottom housing sections 1000 and 1002 together.

The first housing side sections 1004 of the top and bottom housing sections 1000 and 1002 together form the first housing side 104. The second housing side sections 1006 of the top and bottom housing sections 1000 and 1002 together form the second housing side 106. Thus the connecting portion 200 connects the first and second housing sides 104 and 106.

A plug 112 comprising a keyway 114 and a magnetic material 220 is rotatably seated in the cylindrical hole 110 of the top housing section 1000. An actuator 120 made of a magnetisable material and which is preferably diametrically magnetised is rotatably mounted on the connecting portion 200.

The actuator 120 and the magnetic material 220 of the plug 112 are rotationally coupled due to magnetic attraction. Thus rotating the plug 112 rotates the actuator 120.

FIGS. 11a-c illustrate a tenth and preferred embodiment of the invention. FIG. 11a illustrates an exploded isometric projection of the lock 100. FIG. 11b illustrates a front view of the lock 100. FIG. 11c illustrates a section therethrough on the line IV-IV of FIG. 11b.

The lock 100 comprises a housing 102 having a substantially uniform keyway-shaped profile commonly known as a Euro cylinder. The housing 102 of the lock 100 is formed by a cylindrical portion, from the outer surface of which an extension portion integrally radially extends. The housing 102 comprises first and second housing sides 104 and 106 that are connected by an integral joining portion 108. The first and second housing sides 104 and 106 each comprises a cylindrical hole 110. The cylindrical holes 110 are coaxial. The first and second housing sides 104 and 106 each comprises a fastening hole 604.

A cylindrical connecting portion 200 extends completely across a space 116 between the first and second housing sides 104 and 106. The connecting portion 200 has extending portions which extend into the first and second housing sides 104 and 106 to facilitate attachment of the extending portions to the housing 102. The connecting portion 200 seats in the cylindrical hole 110 of the first and second housing sides 104 and 106.

The connecting portion 200 comprises a cylindrical bore 202, a circumferential slot 502 and a pair of fastening bores 616. The axes of the connecting portion 200 and cylindrical bore 202 are offset.

A fastening pin 618 that extends through the fastening holes 604 and corresponding aligned fastening bores 616 joins the first and second housing sides 104 and 106 to the connecting portion 200. The connecting portion 200 is fixed with respect to the first and second housing sides 104 and 106. The fastening pin 618 provides joining means to join the connecting portion 200 to the first and second housing sides 104 and 106.

An actuator 120 in the form of a cam actuator is positioned in the space 116 and rotatably mounted on the connecting portion 200. The actuator 120 comprises a hole 512 and an integral second stage gear 514 formed by an internal gear. A second stage pinion 516 comprising a shaft coupling hole 518 is housed by the cylindrical bore 202 such that it partially protrudes from the circumferential slot 502 of the connecting portion 200, and meshes with the second stage gear 514 of the actuator 120.

A disc member 508 comprising an offset shaft bearing hole 510 is seated on each side of the second stage pinion 516 in the cylindrical bore 202. The disc member 508 is a press fit in the cylindrical bore 202. The disc member 508 may be fastened to the connecting portion 200 by other means, for example by a pin, rivet, screw, clip or retaining ring. Other means may be employed such as an adhesive, welding, brazing or soldering.

An integrally formed first stage pinion set 1100 comprises a pair of first stage pinions 520 joined by a coupling shaft 522 and a clutch rod seating hole 642. The first stage pinion set 1100 extends through the shaft bearing holes 510 of the disc members 508 and the shaft coupling hole 518 of the second stage pinion 516.

The coupling shaft 522 is a press fit in the shaft coupling hole 518 of the second stage pinion 516 so that the first stage pinions 520 and second stage pinion 516 are fixed. In an alternative embodiment, the shaft coupling hole 518 and coupling shaft 522 may comprise at least one spline and/or groove which mesh to increase reliable torque transfer between them. The coupling shaft 522 is rotatably mounted in the shaft bearing holes 510 of the disc members 508.

A first stage gear 524 formed by an internal gear and comprising a clutch keyway 122 is rotatably mounted in each side of the cylindrical bore 202 of the connecting portion 200. Each first stage gear 524 is meshed with a first stage pinion 520. Rotation of a first stage gear 524 transmits rotation to the meshed first stage pinion 520, thus rotating the second stage pinion 516 fixed to it. The second stage pinion 516 transmits rotation to the meshed second stage gear 514 to rotate the actuator 120. The first stage gear 524, first stage pinion 520, second stage pinion 516 and second stage gear 514 thus form rotating means for rotating the actuator 120 about the connecting portion 200. In this embodiment, the arrangement and number of gear teeth of the first stage gear 524, first stage pinion 520, second stage pinion 516 and second stage gear 514 are configured so that the first stage gear 524 and actuator 120 rotate equally and in the same direction.

The cylindrical bore 202 seats a rotatable plug 112 on each side. Each plug 112 comprises a keyway 114, a clutch keyway 122 and a circumferential groove 528.

The fastening pins 618 protrude into the cylindrical bore 202 and engage with the circumferential grooves 528 of the plugs 112 to restrict their axial movement.

The clutch keyways 122 of the plugs 112 seat a clutch element 222 which is rotationally (but not axially) fixed to the clutch keyway 122.

When a key is inserted in the keyway 114 of a plug 112, the tip of its blade makes contact with the end of the clutch element 222 seated in the clutch keyway 122 of the plug 112, moving the clutch element 222 axially towards the first stage gear 524 beside it. A portion of the clutch element 222 thus enters the opposing clutch keyway 122 of the first stage gear 524, rotationally coupling the plug 112 with the first stage gear 524. Thereby rotation of the plug 112 will rotate the actuator 120. The clutch element 222 and the clutch keyway 122 form clutch means for the actuator 120.

A clutch rod 650 is slidably seated in the clutch rod seating hole 642 of the first stage pinion set 1100 so that it is axially moveable and is positioned between the clutch elements 222. When a clutch element 222 moves into the clutch keyway 122 of a first stage gear 524, it may push the clutch rod 650 axially. This may move the clutch element 222 seated in the clutch keyway 122 of the plug 112 on the opposing side away from the clutch keyway 122 of the first stage gear 524 beside it, thereby decoupling the plug 112 and first stage gear 524 of the opposing side.

FIGS. 11a-c illustrate the lock 100 where the clutch element 222 seated in the clutch keyway 122 of the plug 112 of the first housing side 104 is partially seated in the clutch keyway 122 of the first stage gear 524.

The clutch rod 650 provides clutch transfer means. In the first and fourth embodiments, clutch transfer means is provided by a clutch spring 224.

In this embodiment and other embodiments of the present invention, at least one component of the clutch means and/or clutch transfer means is at least partially housed within at least one component of the rotating means to rotate the actuator 120. This may provide a more compact arrangement.

In this embodiment the axes of the cylindrical portion of the housing 102 and plug 112 are offset. The rotational axes of the plug 112 and actuator 120 are offset. The rotational axes of the plug 112 and first stage gear 524 are colinear. Thereby the coupling between the plug 112 and first stage gear 524 is not required to transmit rotation between non-collinear axes, unlike the arrangement disclosed in the fourth embodiment of the present invention.

In alternative embodiment the keyway 114 may not be comprised by the plug 112. If a disc detainer lock mechanism is employed, the plug 112 may house a set of discs. Each disc may comprise a key hole. The key holes may collectively form a keyway 114 to receive a key. In another alternative embodiment the plug 112 may be replaced with a turnable control device.

It is to be appreciated that the embodiments of the invention described above with reference to the accompanying drawings have been given by way of example only and that modifications may be effected. Individual components shown in the drawings are not limited to use in their drawings and they may be used in other drawings and in all aspects of the invention. The invention also extends to the individual components mentioned and/or shown above, taken singly or in any combination.

1. A cylinder lock comprising first and second housing sides, an actuator which is positioned in a space between the first and second housing sides, and a connecting portion which extends completely across the space and connects the first and second housing sides, and wherein the actuator is rotatable about the connecting portion in order to cause operation of locking means.

2. A cylinder lock according to claim 1 in which the connecting portion is fixed with respect to the first and second housing sides.

3. A cylinder lock according to claim 1 and including rotating means for rotating the actuator about the connecting portion.

4. A cylinder lock according to claim 3 in which the rotating means comprises a magnet.

5. A cylinder lock according to claim 3 in which the rotating means comprises two or more gears.

6. A cylinder lock according to claim 3 in which the rotating means comprises at least two sprockets, at least two pulleys, or at least one sprocket and one pulley.

7. A cylinder lock according to claim 3 in which the rotating means comprises two or more wheels which transmit rotation by friction.

8. A cylinder lock according to claim 1 and including a plug or a turnable control device, and in which the plug or the turnable control device is rotatable in the connecting portion.

9. A cylinder lock according to claim 1 in which the connecting portion comprises at least one receiving portion, and in which the receiving portion is for receiving at least one locking component, or is for enabling at least one plug or at least one turnable control device to lock relative to the connecting portion.

10. A cylinder lock according to claim 1 in which the actuator is a cam, a cog wheel or a worm.

11. A cylinder lock according to claim 1 and including a housing.

12. A cylinder lock according to claim 11 in which the connecting portion is integrally formed with housing components.

13. A cylinder lock according to claim 11 in which the connecting portion has first and second sides, and in which one or both of the sides is connected to housing components by joining means.

14. A cylinder lock according to claim 11 in which the connecting portion includes an extending portion, and in which the extending portion extends into housing components for facilitating attachment of the extending portion to the housing components.

15. A cylinder lock according to claim 3 in which the rotating means is configured so that rotation of a plug or turnable control device provides equal rotation of the actuator.

16. (canceled)

17. A cylinder lock according to claim 3 in which the rotating means is configured so that rotation of a plug or turnable control device rotates the actuator in the same direction.

18. A cylinder lock according to claim 1 which requires power for operation, and in which the power is provided by an operator of the cylinder lock.

19. A cylinder lock according to claim 1 and including a plug or a turnable control device, and in which the axis of the plug or the turnable control device and the axis of the actuator are offset.

20. A cylinder lock according to claim 3 and including clutch means, and in which at least one component of the clutch means is at least partially housed within at least one component of the rotating means.

21. A cylinder lock according to claim 3 and including clutch means and clutch transfer means, and in which at least one component of the clutch transfer means is at least partially housed within at least one component of the rotating means.

22.-25. (canceled)
